(19) United States
(12) Patent Application Publication
(10) Pub. No.: US 2014/0043097 A1
(43) Pub. Date: Feb. 13, 2014

(54) ELECTRONIC DEVICE AND NOISE REDUCING METHOD

(71) Applicant: FUJITSU LIMITED, Kawasaki-shi (JP)

(72) Inventor: TERUAKI YAGOSHI, Kawasaki (JP)

(21) Appl. No.: 13/907,963

(22) Filed: Jun. 2, 2013

(30) Foreign Application Priority Data
Aug. 8, 2012 (JP) 2012-176516

(51) Int. Cl. H04B 1/10

(52) U.S. Cl. CPC H04B 1/10
USPC 327/551

(57) ABSTRACT

An electronic device includes a first electronic component and a second electronic component that is connected to the first electronic component via a signal line in which a signal is transmitted and received. An electronic device includes a plurality of conductive lines that is arranged in parallel with the signal line with the signal line interposed therebetween, between the first electronic component and the second electronic component. An electronic device includes a detecting unit that detects an amount of noise which each of the conductive lines receives from another signal line and a correcting unit that reduces noise which the signal received in the signal line receives from the other signal line using the amount of noise detected by the detecting unit.

### CROSS-REFERENCE TO RELATED APPLICATION

This application is based upon and claims the benefit of priority of the prior Japanese Patent Application No. 2012-176516, filed on Aug. 8, 2012, the entire contents of which are incorporated herein by reference.

### FIELD

The embodiments discussed herein are related to an electronic device and a method for reducing noise.

### BACKGROUND

In an information processing unit and the like, a signal line connecting among large scale integration (LSIs) circuits may be affected by cross talk from another signal line, so that a malfunction may be caused in some cases. For example, taking wiring of a fast I/O differential signal in an LSI as an example, a driver circuit and a receiver circuit are connected by fast differential signal wirings P and N. However, the distance from another signal line may be different between P and N. In this case, the amount of noise received by P differs from that received by N. Therefore, distortion is generated in a wave form received by the differential signal wiring, and a voltage value of High level or Low level is not ensured, so that a malfunction is caused in the LSI.

As a method for preventing such a malfunction caused by cross talk, there is known a technique that analyzes aged deterioration of parts and influence by the cross talk with simulations in advance, and sets excessive amplitude of an output such that influence of noise is reduced even when the influence as described above is effected. Also, there is known a technique for improving noise immunity by making the differential signal wirings to have redundancy so that, even one differential signal wiring is affected by the noise, the other differential signal wiring is used.

An example is described in Japanese Laid-open Patent Publication No. 10-262086.

However, there is a problem that power consumption is large in the related art. For example, in a method using a simulation, excessive amplitude is continued to be output, so that the power consumption is increased. In a method for deploying redundancy, it is determined that which differential signal wiring out of two pairs of differential signal wirings is more affected by the noise, and processing for selecting differential signal wiring less affected is performed. As described herein, there are many irregular processing and the power consumption is increased.

A method for detecting and correcting the amount of noise of the cross talk from the fast differential signal wirings P and N is also considered. In this method, information of an amplitude value before affected by the cross talk and an amplitude value after affected by the cross talk is used, so that the circuit is complicated and the cost is increased. Therefore, it is hard to say that the above-described method is preferable.

### SUMMARY

According to an aspect of an embodiment, a electronic device includes a first electronic component; a second electronic component that is connected to the first electronic component via a signal line in which a signal is transmitted and received; a plurality of conductive lines that is arranged in parallel with the signal line with the signal line interposed therebetween, between the first electronic component and the second electronic component; a detecting unit that detects an amount of noise which each of the conductive lines receives from another signal line; and a correcting unit that reduces noise which the signal received in the signal line receives from the other signal line using the amount of noise detected by the detecting unit.

The object and advantages of the invention will be realized and attained by means of the elements and combinations particularly pointed out in the claims.

It is to be understood that both the foregoing general description and the following detailed description are exemplary and explanatory and are not restrictive of the invention, as claimed.

### BRIEF DESCRIPTION OF DRAWINGS

FIG. 1 is a block diagram illustrating a configuration of an electronic device according to a first embodiment;

FIG. 2 is a diagram for explaining cross talk received by a signal line (S) according to the first embodiment;

FIG. 3 is a circuit diagram illustrating a configuration of a correction circuit;

FIG. 4 is a circuit diagram of an inverting circuit;

FIG. 5 is a circuit diagram of a non-inverting circuit;

FIG. 6 is a circuit diagram of an adding circuit;

FIG. 7 is a circuit diagram of an attenuator circuit;

FIG. 8 is a diagram illustrating a relationship between the amount of the cross talk and the distance from a source of the cross talk;

FIG. 9 is a flowchart illustrating a flow of noise reduction processing according to the first embodiment;

FIG. 10 is a block diagram illustrating a configuration of an electronic device according to a second embodiment;

FIG. 11 is a diagram for explaining cross talk received by a signal line according to the second embodiment;

FIG. 12 is a circuit diagram illustrating a configuration of a correction circuit according to the second embodiment;

FIG. 13 is a diagram illustrating a relationship between the amount of the cross talk and the distance from a source of the cross talk;

FIG. 14 is a flowchart illustrating a flow of noise reduction processing according to the second embodiment;

FIG. 15 is a diagram illustrating a signal before correction; and

FIG. 16 is a diagram illustrating a signal after correction.

### DESCRIPTION OF EMBODIMENTS

Preferred embodiments of the present invention will be explained with reference to accompanying drawings.

It is not intended that the present invention is limited by the embodiments.

### [a] First Embodiment

### Configuration of Electronic Device

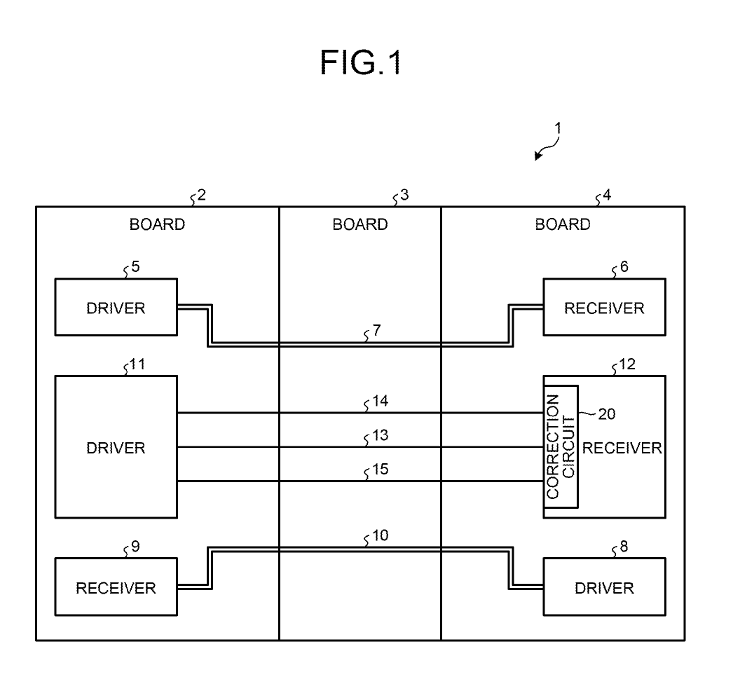

FIG. 1 is a block diagram illustrating a configuration of an electronic device according to a first embodiment. For example, an electronic device 1 is a device on which an LSI and the like are mounted and includes a board 2, a board 3, and a board 4 as illustrated in FIG. 1. Each of the boards is a board on which the LSI, an electronic circuit, an electron element and the like are mounted, that is, a printed circuit board for example. The number of boards represented herein is merely an example and the embodiment is not limited thereto.

The board 2 includes a driver 5, a receiver 9, and a driver 11 mounted thereon. The board 4 includes a receiver 6, a driver 8, and a receiver 12 mounted thereon. The driver 5 and the receiver 6 are connected via a signal line 7 that is a transmission path of a signal. The driver 5 is a circuit that transmits a signal to the receiver 6 via the signal line 7. The receiver 6 is a circuit that receives a signal from the driver 5 via the signal line 7.

The driver 8 and the receiver 9 are connected via a signal line 10, which is a transmission path of the signal. The driver 8 is a circuit that transmits a signal to the receiver 9 via the signal line 10. The receiver 9 is a circuit that receives a signal from the driver 8 via the signal line 10.

The driver 11 and the receiver 12 are connected via a signal line (S) 13 that is a transmission path of the signal, a detection line (G1) 14, and a detection line (G2) 15. The driver 11 is a circuit that transmits a signal to the receiver 9 via the signal line (S) 13. The detection line (G1) 14 and the detection line (G2) 15 are arranged in parallel with the signal line (S) 13 with the signal line (S) 13 interposed therebetween, and connect the driver 11 and the receiver 12. The detection line (G1) 14 and the detection line (G2) 15 are supplied with electric power from the driver 11 or the receiver 12. The detection line (G1) 14 and the detection line (G2) 15 may be a conductive line such as a pattern.

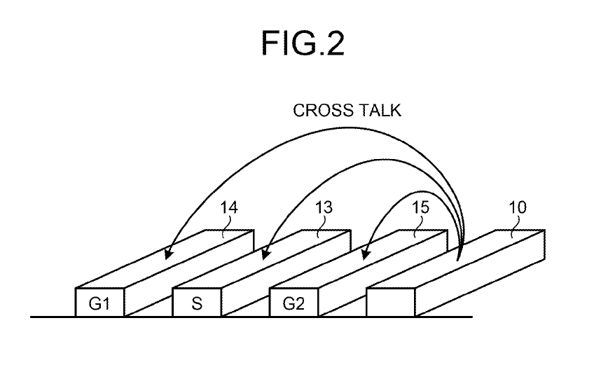

The receiver 12 is a circuit that includes a correction circuit 20 and receives a signal from the driver 11 via the signal line (S) 13. The receiver 12 may reduce the amount of the cross talk received by the signal line (S) 13 from the signal line 10, by the correction circuit 20. Here, the cross talk received by the signal line (S) 13 from the signal line 10 will be described. FIG. 2 is a diagram for explaining the cross talk received by the signal line (S) according to the first embodiment.

As illustrated in FIG. 2, the detection line (G1) 14 and the detection line (G2) 15 are arranged with the signal line (S) 13 interposed therebetween. The detection line (G2) 15 is arranged between the signal line 10 that is another signal line not being a target of noise removal and the signal line (S) 13 being a target of noise removal. Accordingly, the detection line (G2) 15 is at a position closest to the signal line 10, sequentially followed by the signal line (S) 13, and the detection line (G1) 14. In the example illustrated in FIG. 2, the signal line (S) 13 and the signal line 10 are parallel to each other, however, the embodiment is not limited thereto.

In such a state, if the driver 8 transmits a signal to the signal line 10 at timing when the driver 11 transmits a signal to the signal line (S) 13, the signal is leaked from the signal line 10 and cross talk is generated in another signal line and the like. Accordingly, the signal flowing in the signal line (S) 13 also receives the cross talk, so that the receiver 12 does not receive it as a normal signal. The amount of cross talk received from the signal line 10 is the largest in the detection line (G2) 15, which is closest to the signal line 10, and the amount thereof is the smallest in the detection line (G1) 14, which is farthest from the signal line 10.

The correction circuit 20 of the receiver 12 detects the amount of noise received from the signal line 10 by each of the detection line (G1) 14 and the detection line (G2) 15. The correction circuit 20 removes the noise received by the signal line (S) 13 from the signal line 10, using the detected amount of noise. In this manner, the receiver 12 may receive a signal of which noise is reduced.

### Details of Correction Circuit

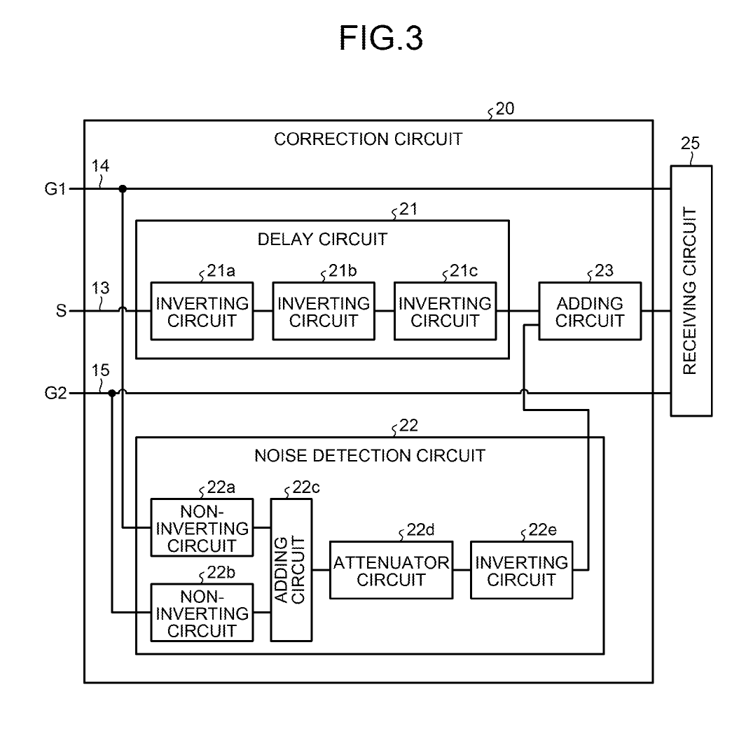

FIG. 3 is a circuit diagram illustrating a configuration of the correction circuit. As illustrated in FIG. 3, the correction circuit 20 illustrated in FIG. 1 includes a delay circuit 21, a noise detection circuit 22, and an adding circuit 23, and is connected to a receiving circuit 25. As described above, the receiver 12 includes the correction circuit 20 and the receiving circuit 25.

The delay circuit 21 is a circuit that delays the signal in the signal line (S) 13 to match the timing with respect to the detected noise. The delay circuit 21 is a circuit that includes an inverting circuit 21a, an inverting circuit 21b, and an inverting circuit 21c.

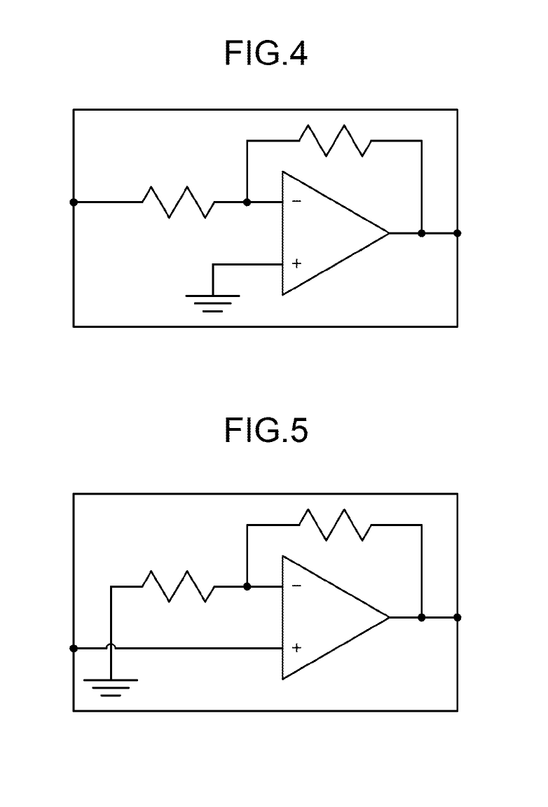

FIG. 4 is a circuit diagram of the inverting circuit. As illustrated in FIG. 4, each of the inverting circuits has a typical circuit configuration in which a resistor is connected to an inverting input terminal (−) to add an input, a non-inverting input terminal (+) is grounded, and negative feedback is applied to the inverting input terminal (−) from an output using feedback resistance. As described above, each of the inverting circuits 21a to 21c is a circuit that inverts and outputs an input signal. The number of the inverting circuits is merely an example.

The noise detection circuit 22 includes a non-inverting circuit 22a, a non-inverting circuit 22b, an adding circuit 22c, an attenuator circuit 22d, and an inverting circuit 22e, by which the amount of the cross talk received by each of the detection line (G1) 14 and the detection line (G2) 15 is detected.

The non-inverting circuit 22a is a circuit that non-inverts a signal in the detection line (G1) 14 and outputs the signal to the adding circuit 22c. FIG. 5 is a circuit diagram of the non-inverting circuit. As illustrated in FIG. 5, the non-inverting circuit 22a has a typical circuit configuration in which an input is added to the non-inverting input terminal (+), the resistor is connected to the inverting input terminal (−) to be grounded, and the negative feedback is applied from the output by the feedback resistance.

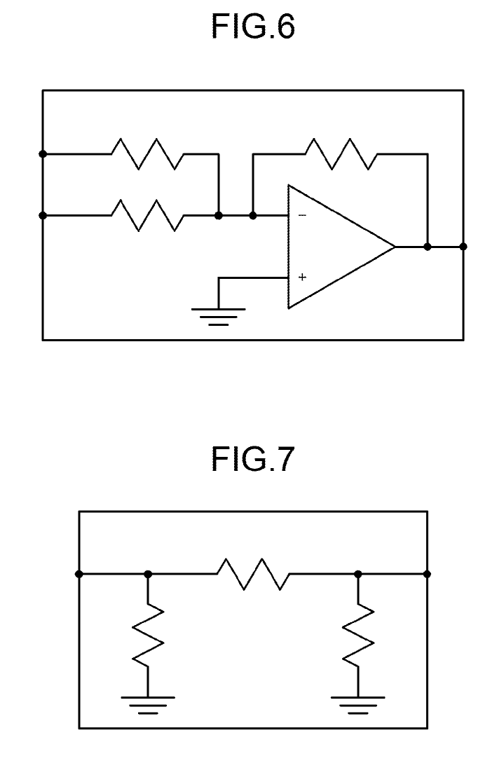

The non-inverting circuit 22b is a circuit that outputs a signal in the detection line (G2) 15 to the adding circuit 22c. The non-inverting circuit 22b is represented by the same circuit diagram as that in FIG. 5. The adding circuit 22c is a circuit that adds a signal input from the non-inverting circuit 22a to a signal input from the non-inverting circuit 22b, and outputs a resultant to the attenuator circuit 22d. FIG. 6 is a circuit diagram of the adding circuit. As illustrated in FIG. 6, the adding circuit 22c has a typical circuit configuration in which the non-inverting input terminal (+) is grounded, an input is connected and added to the inverting input terminal (−). The amount of the cross talk received by each of the detection line (G1) 14 and the detection line (G2) 15 is detected by the adding circuit 22c.

The attenuator circuit 22d is a circuit that attenuates a signal input from the adding circuit 22c to an estimated level of the amount of noise received by the signal line (S) 13. FIG. 7 is a circuit diagram of the attenuator circuit. As illustrated in FIG. 7, the attenuator circuit 22d is a circuit that maintains certain impedance of input/output using a plurality of resistors and may change an attenuation rate. Although a π-type is illustrated in FIG. 7, the embodiment is not limited thereto. The other type such as a T-type may be employed. The attenuator circuit 22d attenuates the amount of the cross talk detected in the detection line (G1) 14 and the detection line (G2) 15, in other words, the amount of noise to an estimated level of the amount of noise received by the signal line (S) 13. The inverting circuit 22e is a circuit that inverts a signal input from the attenuator circuit 22d and outputs the signal to the adding circuit 23.

The adding circuit 23 is a circuit that adds a signal input from the noise detection circuit 22 to a signal input from the delay circuit 21 and removes noise from a signal in the signal line (S) 13. The receiving circuit 25 is a circuit that extracts a received signal from a signal input from the adding circuit 23, that is, a signal of which amount of noise is reduced.

### Description of Noise Reduction

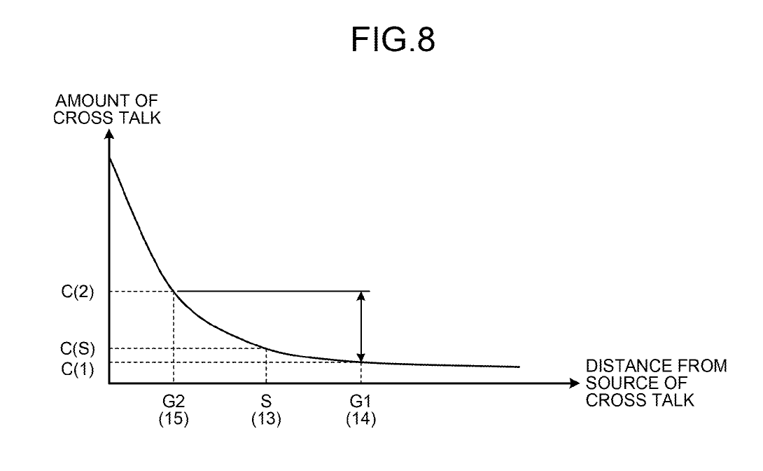

FIG. 8 is a diagram illustrating a relationship between the amount of the cross talk and the distance from a source of the cross talk. As illustrated in FIG. 8, the farther the distance from the source of the cross talk is, the smaller the amount of the cross talk that will affect is. Specifically, in a case where the signal line 10 in FIG. 1 is the source, the amount of the cross talk “C(2)” received by the detection line (G2) 15 is the largest, followed by the amount of the cross talk “C(S)” received by the signal line (S) 13, and the amount of the cross talk “C(1)” received by the detection line (G1) 14 is the smallest. That is, C(2)>C(S)>C(1) is established.

Therefore, as illustrated in FIG. 8, the amount of noise is attenuated in the attenuator circuit using a cross talk rate of “C(S)” previously calculated from the amount of the cross talk “C(2)” received by the detection line (G2) 15 and the amount of the cross talk “C(1)” received by the detection line (G1) 14. The adding circuit 23 adds the amount of noise attenuated and inverted in the attenuator circuit 22d to a signal in the signal line (S) 13. As a result, the amount of the cross talk “C(S)” received by the signal line (S) 13 may be reduced in the signal in the signal line (S) 13.

### Process Flow

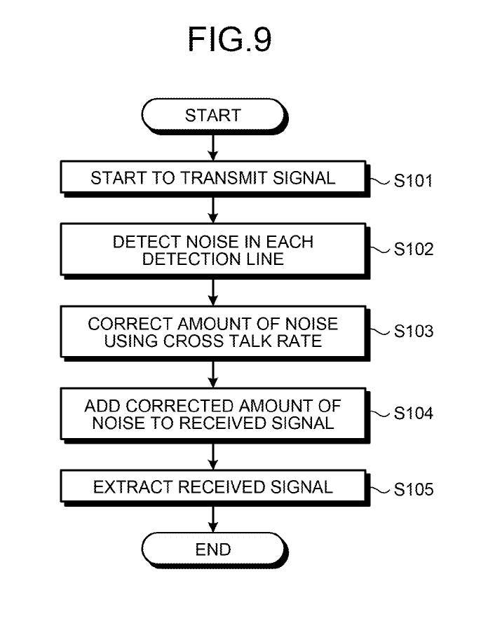

FIG. 9 is a flowchart illustrating a flow of noise reduction processing according to the first embodiment. As illustrated in FIG. 9, when transmission of a signal from the driver 11 to the receiver 12 is started (S101), the correction circuit 20 detects noise from each of the detection line (G1) 14 and the detection line (G2) 15 (S102).

Subsequently, the correction circuit 20 corrects the amount of the detected noise using a cross talk rate (S103), and adds the resultant to a signal in the signal line (S) 13 (S104). That is, the correction circuit 20 adds the detected and corrected amount of noise to the received signal. Then the receiving circuit 25 extracts the received signal from the signal input from the correction circuit 20, that is, a signal of which amount of noise is reduced (S105).

As described above, with respect to the signal line (S) 13 connecting electronic components, the electronic device 1 according to the first embodiment may estimate the amount of noise received by the signal line (S) 13 from the amount of noise detected by two detection lines arranged in parallel with the signal line (S) 13 interposed therebetween, and remove the noise. As a result, a circuit for noise removal is simplified and power consumption may be suppressed.

In the first embodiment, the amount of cross talk noise received by the signal line (S) 13 is corrected using a cross talk rate estimated from a characteristic of a substrate. For example, as illustrated in FIG. 8, the characteristic of the substrate includes, for example, a graph representing a relationship between the source of the cross talk and the amount of the cross talk. It is sufficient that such a characteristic is information that may uniquely specify the relationship between the source of the cross talk and the amount of the cross talk by the substrate.

### [b] Second Embodiment

In the first embodiment, an example in which the driver 11 transmits a signal to the receiver 12 using one signal line is described. However, the present invention is not limited thereto, and may also be applied to a circuit that transmits a signal via a differential signal line using two signal lines having different phases. In a second embodiment, an example in which a noise difference in the differential signal line is reduced will be described.

### Configuration of Electronic Device

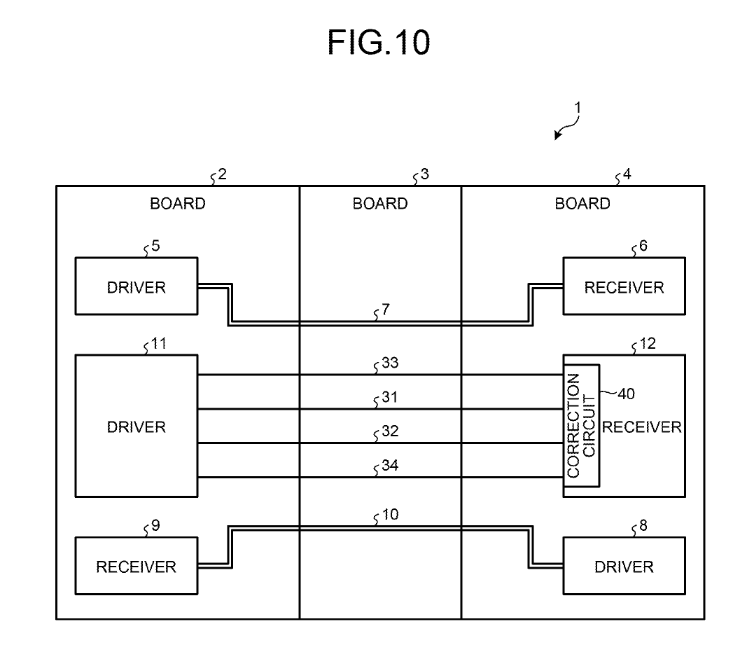

FIG. 10 is a block diagram illustrating a configuration of an electronic device according to the second embodiment. Similarly to the first embodiment, the electronic device 1 is a device including the LSI and the like mounted thereon, and includes the board 2, the board 3, and the board 4 as illustrated in FIG. 10.

The second embodiment is different from the first embodiment in that the driver 11 and the receiver 12 are connected via a signal line (P) 31, a signal line (N) 32, a detection line (G11) 33, and a detection line (G22) 34. Specifically, the driver 11 is a circuit that transmits a signal to the receiver 9 using the signal line (P) 31 and the signal line (N) 32. More specifically, the driver 11 transmits a signal via the signal line (P) 31, and also transmits a signal to the signal line (N) 32 in an opposite phase of the signal line (P) 31.

The detection line (G11) 33 and the detection line (G22) 34 are arranged in parallel with each of the signal line (P) 31 and the signal line (N) 32 with these signal lines interposed therebetween. Electric power is supplied to these detection lines from the driver 11 or the receiver 12. In addition, each of the detection lines may be a conductive line such as a pattern.

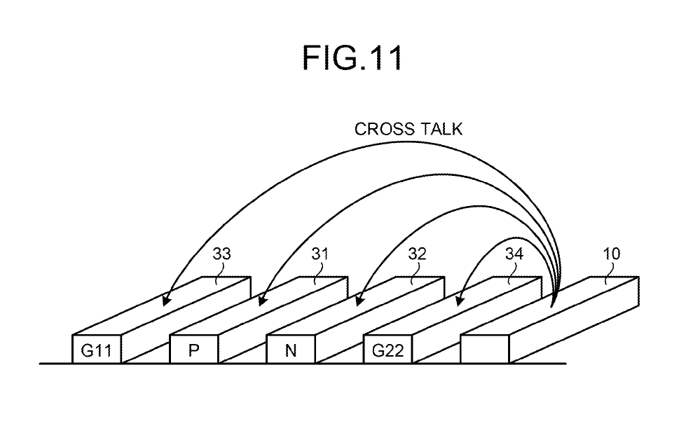

FIG. 11 is a diagram for explaining the cross talk received by the signal lines according to the second embodiment. As illustrated in FIG. 11, the detection line (G11) 33 and the detection line (G22) 34 are arranged with the signal line (P) 31 and the signal line (N) 32 interposed therebetween. The detection line (G22) 34 is arranged between the signal line 10, which is a source of the noise, and the signal line (N) 32. The detection line (G11) 33 is arranged at a position farthest from the signal line 10, in other words, a position facing the signal line 10 with the detection line (G22) 34, the signal line (N) 32, and the signal line (P) 31 interposed therebetween. Therefore, the detection line (G22) 34 is at a position closest to the signal line 10, sequentially followed by the signal line (N) 32, the signal line (P) 31, and the detection line (G11) 33. In FIG. 11, an example in which the signal line (P) 31 and the signal line (N) 32 are in parallel with the signal line 10 is illustrated, however, the present invention is not limited thereto.

In such a state, if the driver 8 transmits a signal to the signal line 10 at timing when the driver 11 transmits a signal to the signal line (P) 31 and the signal line (N) 32, the signal is leaked from the signal line 10 and the cross talk is generated in another signal line and the like. Accordingly, the signal flowing in the signal line (P) 31 and the signal line (N) 32 also receives the cross talk, so that the receiver 12 does not receive it as a normal signal. The amount of the cross talk received from the signal line 10 is the largest in the detection line (G22) 34, which is closest to the signal line 10, and the amount thereof is the smallest in the detection line (G11) 33, which is farthest from the signal line 10.

A correction circuit 40 of the receiver 12 detects the amount of noise received by each of the detection line (G11) 33 and the detection line (G22) 34 from the signal line 10. The correction circuit 40 removes a difference in the amounts of noise received by the signal line (P) 31 and the signal line (N) 32 from the signal line 10, using the detected amount of noise. In this manner, the receiver 12 may receive a signal of which noise is reduced.

### Details of Correction Circuit

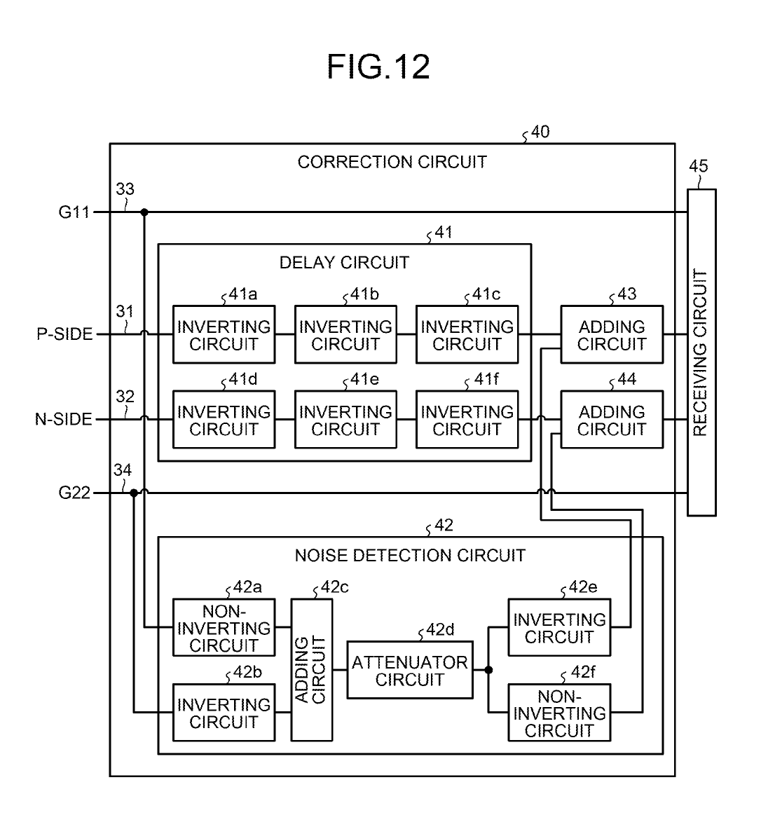

FIG. 12 is a circuit diagram illustrating a configuration of the correction circuit according to the second embodiment. As illustrated in FIG. 12, the correction circuit 40 illustrated in FIG. 10 includes a delay circuit 41, a noise detection circuit 42, an adding circuit 43, and an adding circuit 44, and is connected to a receiving circuit 45. As described above, the receiver 12 includes the correction circuit 40 and the receiving circuit 45. A circuit diagram of each of the circuits is the same as the circuit diagram described in the first embodiment, so that detailed description thereof is not repeated here.

The delay circuit 41 is a circuit that delays the signal in the signal line (P) 31 and the signal line (N) 32 to match the timing with respect to the detected noise. The delay circuit 41 includes an inverting circuit 41a, an inverting circuit 41b, and an inverting circuit 41c with respect to the signal line (P) 31. Each of the inverting circuits 41a to 41c is a circuit that inverts and outputs an input signal. The delay circuit 41 includes an inverting circuit 41d, an inverting circuit 41e, and an inverting circuit 41f with respect to the signal line (N) 32. Each of the inverting circuits 41d to 41e is a circuit that inverts and outputs an input signal. The number of the inverting circuits is merely an example.

The noise detection circuit 42 includes a non-inverting circuit 42a, an inverting circuit 42b, an adding circuit 42c, an attenuator circuit 42d, an inverting circuit 42e, and a non-inverting circuit 42f, by which a difference in the amounts of the cross talk received by each of the detection line (G11) 33 and the detection line (G22) 34 is detected, and a difference in the amounts of noise in the signal line (P) and the signal line (N) is calculated.

The non-inverting circuit 42a is a circuit that non-inverts a signal in the detection line (G11) 33 and outputs the signal to the adding circuit 42c. The inverting circuit 42b is a circuit that inverts a signal in the detection line (G22) 34 and outputs the signal to the adding circuit 42c. The adding circuit 42c is a circuit that adds a signal input from the non-inverting circuit 42a to a signal input from the inverting circuit 42b, and outputs a resultant to the attenuator circuit 42d. A difference in the amounts of the cross talk received by each of the detection line (G11) 33 and the detection line (G22) 34 is detected by the adding circuit 42c.

The attenuator circuit 42d is a circuit that corrects a signal input from the adding circuit 42c into a difference in the amounts of noise (Q1) of the signal line (P) and the signal line (N), halves the corrected signal so as to be added to the signal line (P) and the signal line (N), and outputs the signal to the inverting circuit 42e and the non-inverting circuit 42f. That is, the attenuator circuit 42d corrects the difference in the amounts of the cross talk detected in the detection line (G11) 33 and the detection line (G22) 34, in other words, the difference in the amounts of noise into the difference in amount of noise of the signal line (P) and the signal line (N), and outputs the halved amount of noise to the inverting circuit 42e and the non-inverting circuit 42f.

The inverting circuit 42e is a circuit that inverts a signal input from the attenuator circuit 42d, in other words, a half of the signal input from the adding circuit 42c and outputs the signal to the adding circuit 43. The non-inverting circuit 42f is a circuit that non-inverts the signal input from the attenuator circuit 42d, in other words, the signal input from the adding circuit 42c and outputs the signal to the adding circuit 44.

The adding circuit 43 is a circuit that adds the signal input from the inverting circuit 42e to the signal input from the inverting circuit 41c of the delay circuit 41, and corrects the difference in the amount of noise from the signal in the signal line (P) 31. The adding circuit 44 is a circuit that adds the signal input from the non-inverting circuit 42f to the signal input from the inverting circuit 41f of the delay circuit 41, and corrects the difference in the amount of noise from the signal in the signal line (N) 32. The receiving circuit 25 is a circuit that synthesizes a signal on a P-side input from the adding circuit 43 and a signal on an N-side input from the adding circuit 44, and extracts the received signal.

### Description of Noise Reduction

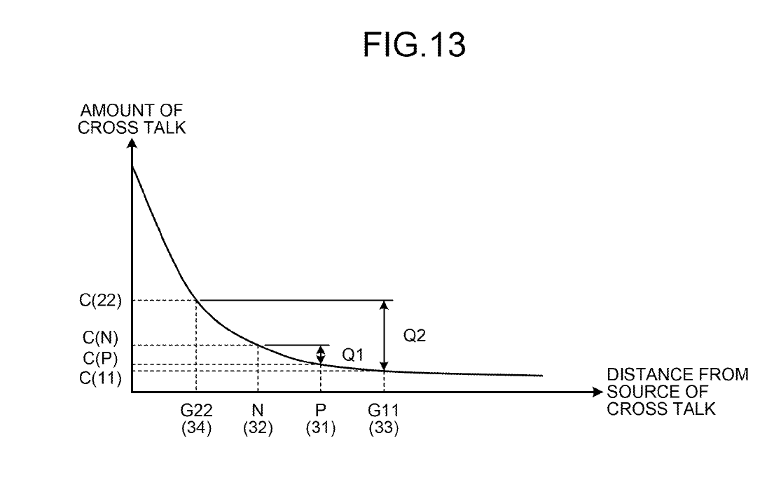

FIG. 13 is a diagram illustrating a relationship between the amount of the cross talk and the distance from the source of the cross talk. As illustrated in FIG. 13, the farther the distance from the source of the cross talk is, the smaller the amount of the cross talk that will affect is. Specifically, in a case where the signal line 10 in FIG. 10 is the source, the amount of the cross talk “C(22)” received by the detection line (G22) 34 is the largest, followed by the amount of the cross talk “C(N)” received by the signal line (N) 32, and the amount of the cross talk “C(P)” received by the signal line (P) 31. The amount of the cross talk “C(G22)” received by the detection line (G11) 33 is the smallest. That is, C(22)>C(N)>C(P)>C(11) is established.

Therefore, as illustrated in FIG. 13, a difference between the amount of the cross talk “C(22)” received by the detection line (G22) 34 and the amount of the cross talk “C(11)” received by the detection line (G11) 33 becomes “C(22)−C(11)=Q2”. It is to be noted that a difference between the amount of the cross talk “C(N)” received by the signal line (N) 32 and the amount of the cross talk “C(P)” received by the signal line (P) 31 becomes “C(N)−C(P)=Q1”.

The amount of cross talk noise detected in the detection line (G11) 33 is non-inverted, the amount of cross talk noise detected in the detection line (G22) 34 is inverted, and they are added to each other (an output is inverted). Accordingly, the amount of cross talk noise between the detection line (G11) 33 and the detection line (G22) 34 is detected. In addition, the amount of cross talk noise in P/N is calculated from the amount of cross talk noise between the detection line (G11) 33 and the detection line (G22) 34 using a cross talk rate between the P and N estimated by the characteristic of the substrate, and is reduced to the amount of noise of the differential cross talk. For example, as illustrated in FIG. 13, the characteristic of the substrate includes, for example, a graph representing a relationship between the source of the cross talk and the amount of the cross talk. It is sufficient that such a characteristic is information that may uniquely specify the relationship between the source of the cross talk and the amount of the cross talk by the substrate.

Thereafter, the signal is halved by the attenuator circuit 42d from the attenuated voltage, the halved amount of noise of the cross talk is added to the signal line (P) 31 after inverted, and added to the signal line (N) 32 after non-inverted. In this manner, the amount of the cross talk from the other signal is detected by using the detection line (G11) 33 and the detection line (G22) 34, a difference generated in the signal line (P) 31 and the signal line (N) 32 is reduced by the correction circuit 40, and distortion in a wave form received by the differential signal is suppressed to prevent a malfunction.

### Process Flow

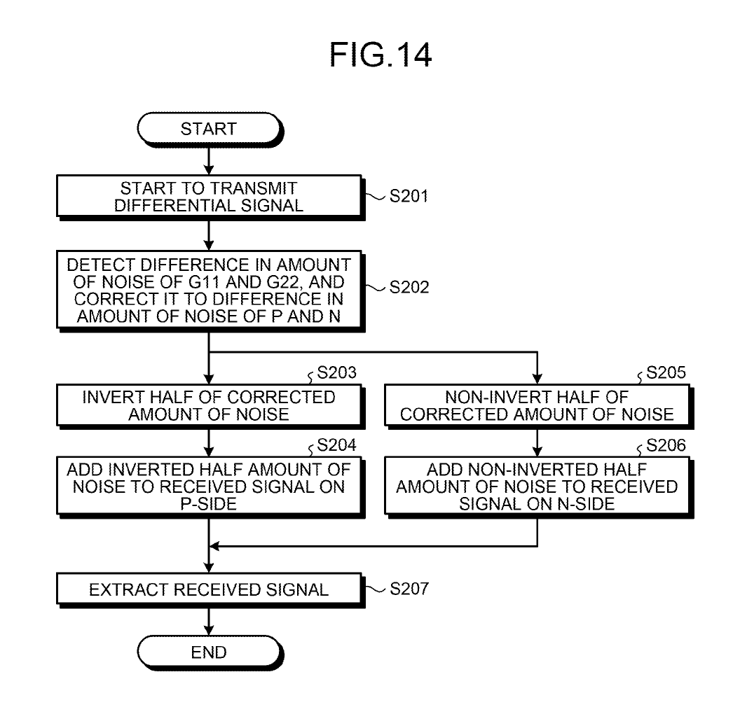

FIG. 14 is a flowchart illustrating a flow of noise reduction processing according to the second embodiment. As illustrated in FIG. 14, when transmission of a signal from the driver 11 to the receiver 12 is started using the differential signal line (S201), the correction circuit 40 detects a difference in the amounts of noise of the detection line (G11) 33 and the detection line (G22) 34 (S202).

Subsequently, the correction circuit 40 corrects the detected difference in the amount of noise into a difference in the amounts of noise of the signal line (P) and the signal line (N). The corrected amount of noise is halved and inverted (S203), and added to the signal in the signal line (P) 31 (S204). Similarly, the correction circuit 40 corrects the detected difference in the amount of noise into a difference in the amounts of noise of the signal line (P) and the signal line (N). The corrected amount of noise is halved and non-inverted (S205), and added to the signal in the signal line (N) 32 (S206). The processes in S203 and S204 and the processes in S205 and S206 may be performed in parallel. Then the receiving circuit 45 extracts the received signal from each of the signals input from the correction circuit 40, that is, a signal on the P-side and a signal on the N-side each of which amount of noise is reduced (S207).

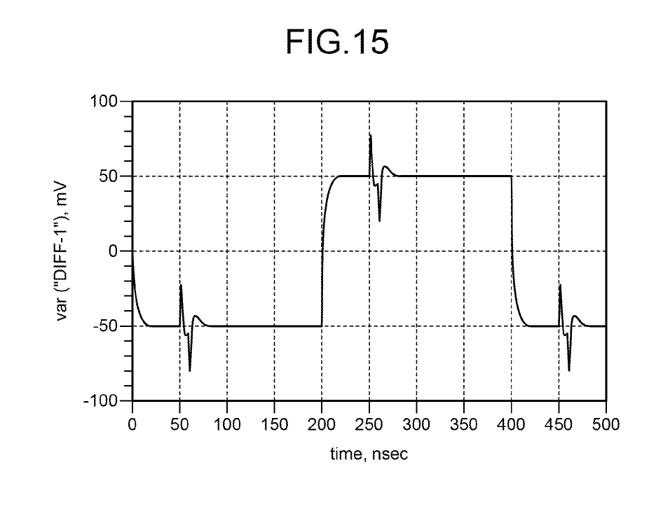

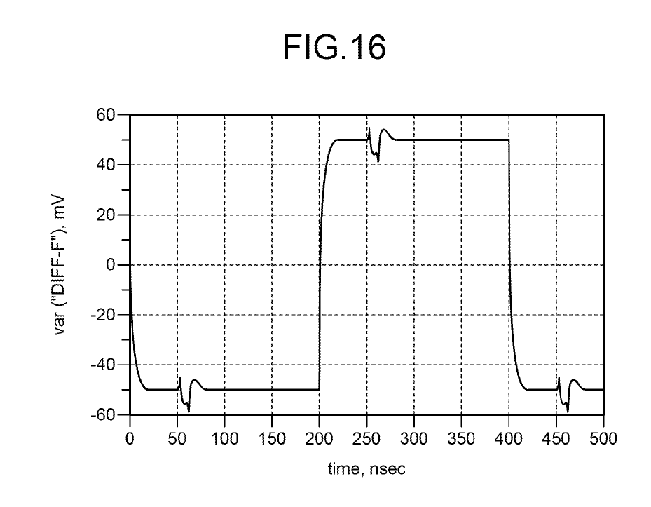

Here, a signal before noise removal (before correction) and a signal after noise removal (after correction) are compared with each other. FIG. 15 is a diagram illustrating the signal before correction. FIG. 16 is a diagram illustrating the signal after correction. With respect to the signal illustrated in FIG. 15, the vertical axis represents a difference between the signal on the P-side and the signal on the N-side each of which is input to the delay circuit 41 of the correction circuit 40, and the horizontal axis represents time (ns). With respect to the signal illustrated in FIG. 16, the vertical axis represents a difference between the signal on the P-side and the signal on the N-side each of which is output from the correction circuit 40, and the horizontal axis represents time (ns).

In FIG. 15, the difference between the signal on the P-side and the signal on the N-side is disturbed substantially at 50 (ns), 250 (ns), and 450 (ns). This means that influence of the noise, that is, of the cross talk is large. In contrast, as compared with FIG. 15, the difference between the signal on the P-side and the signal on the N-side is small substantially at 50 (ns), 250 (ns), and 450 (ns) in FIG. 16. This means that the influence of the noise, that is, of the cross talk may be reduced.

As described above, in the differential signal lines P and N, the signals of the detection line (G11) 33 and the detection line (G22) 34 are arranged in parallel on both sides of the P and N, and the amount of the cross talk received by the G11 and G22 from outside is detected.

A difference is calculated from the amount of the cross talk detected in the G11 and G22, and the amount of cross talk noise of the P and N is calculated using a cross talk rate of the substrate from the calculated difference. Subsequently, the calculated amount of cross talk noise between the P and N is halved, the halved amount of cross talk noise is added to the P, and the inverted amount of cross talk noise is added to the N. In this manner, the difference in the amounts of cross talk noise between the P and N is reduced. As a result, a malfunction is not caused even if different noise is received by the signal lines P and N, so that the influence of the cross talk noise may be reduced. In addition, the circuit for noise removal is simplified, so that the power consumption may be suppressed.

### [c] Third Embodiment

Although the embodiments of the present invention have been described so far, the present invention may be embodied in various different modification other than the above-described embodiments. Different embodiments will be described below.

### Detection Line

In the first embodiment and the second embodiment, an example in which the detection line is connected from the driver to the receiver is described. However, the present invention is not limited thereto. It is sufficient that electric power is supplied to the detection line so as to be affected by the cross talk, so that the detection line may be connected only to the receiver.

### Target Device

In the first embodiment and the second embodiment, the electronic device including the LSI and the like mounted thereon is described as an example, however, the present invention is not limited thereto. The present invention may also be applied to electronic circuits or electron elements in the LSI.

### System

Among the processes described in the present embodiment, all or part of the processes described to be automatically performed may be manually performed.

Alternatively, all or part of the processes described to be manually performed may be automatically performed using a known method. In addition, information including a processing procedure, a control procedure, a specific name, and various data or parameters illustrated in this document and the drawings may be changed as appropriate unless otherwise specified.

In addition, each component of the illustrated devices represents a conceptual function, and the components are not always physically configured as illustrated in the drawings. That is, a concrete form of distribution or integration of each of the devices is not limited to that in the drawings. Specifically, all or part of the devices may be configured to be distributed or integrated, functionally or physically, in an optional unit depending on various loads, usage, and the like.

According to a first embodiment of the present invention, power consumption may be suppressed.

All examples and conditional language recited herein are intended for pedagogical purposes of aiding the reader in understanding the invention and the concepts contributed by the inventor to further the art, and are not to be construed as limitations to such specifically recited examples and conditions, nor does the organization of such examples in the specification relate to a showing of the superiority and inferiority of the invention. Although the embodiments of the present invention have been described in detail, it should be understood that the various changes, substitutions, and alterations could be made hereto without departing from the spirit and scope of the invention.

What is claimed is:

1. An electronic device comprising:
a first electronic component;
a second electronic component that is connected to the first electronic component via a signal line in which a signal is transmitted and received;
a plurality of conductive lines that is arranged in parallel with the signal line with the signal line interposed therebetween, between the first electronic component and the second electronic component;
a detecting unit that detects an amount of noise which each of the conductive lines receives from another signal line; and
a correcting unit that reduces noise which the signal received in the signal line receives from the other signal line using the amount of noise detected by the detecting unit.

2. The electronic device according to claim 1, wherein
the first electronic component and the second electronic component are connected via a differential signal line including a first signal line and a second signal line that transmits a signal in an opposite phase of the first signal line,
the conductive lines are arranged in parallel with the differential signal line with the differential signal line interposed therebetween, between the first electronic component and the second electronic component, and
the correcting unit reduces noise which a signal received in the first signal line receives and reduces noise which a signal received in the second signal line receives, using the amount of noise detected by the detecting unit.

3. The electronic device according to claim 2, wherein the correcting unit inverts an amount of noise that is half of a difference in each amount of noise detected by the detecting unit and adds a resultant to the signal which the first signal line receives to reduce noise received by the signal received in the first signal line, and non-inverts the halved amount of noise and adds a resultant to the signal which the second signal line receives to reduce noise received by the signal received in the second signal line.

4. A noise reducing method comprising:
detecting an amount of noise received from another signal line by a plurality of conductive lines arranged in parallel with a signal line connecting a first electronic component and a second electronic component with the signal line interposed therebetween between the first electronic component and the second electronic component; and
reducing noise which the signal line received in the signal line receives from the other signal line using the detected amount of noise.
